(19) United States
(12) Patent Application Publication
(10) Pub. No.: US 2018/0328538 A1
(43) Pub. Date: Nov. 15, 2018

(54) TOOL SAFETY SYSTEM AND METHOD OF USE

(71) Applicant: Chad A. Kirby, Overland Park, KS (US)

(72) Inventor: Chad A. Kirby, Overland Park, KS (US)

(21) Appl. No.: 15/976,347

(22) Filed: May 10, 2018

Related U.S. Application Data
(60) Provisional application No. 62/505,354, filed on May 12, 2017.

(51) Int. Cl. F16P 3/14; B23Q 5/58

(52) U.S. Cl. CPC F16P 3/147; B25F 5/02; B23Q 5/58

(57) ABSTRACT

A tool safety system and method of use thereof which includes a sensor device for detecting when personal protective equipment (“PPE”) is being worn or in proximity with an associated tool. Sensors may be included in the equipment to determine if the equipment is properly being worn, such as pressure or skin-contact sensors within gloves and hard hats, or contact switches for visors to detect that the visor is in a down position.

### CROSS-REFERENCE TO RELATED APPLICATION

This application claims priority in U.S. Provisional Patent Application No. 62/505,354 Filed May 12, 2017, which is incorporated herein by reference.

### BACKGROUND OF THE INVENTION

### 1. Field of the Invention

The present invention relates generally to a tool safety system and method for use thereof, and more specifically to a wireless safety system for detecting safety equipment in proximity to a tool before activating the tool.

### 2. Description of the Related Art

The United States Department of Labor's Occupational Safety & Health Administration (“OSHA”) requires that workers on construction or industrial sites use personal protective equipment (“PPE”) when performing certain jobs or when using certain tools. The PPE required may differ depending on the piece of equipment being used as well as the type of job being performed, however typically the requirements are fairly standard, including eye and face protection (e.g. safety glasses or face shields), foot protection (e.g. safety toed boots), hand protections (e.g. gloves), head protection (e.g. hard hats), hearing protection, body protection, and other items. Proper certification to use certain tools or to be in certain access areas may also be required. A common problem resulting in workplace injuries is that workers often wear only some or none of their required PPE.

Contracts and jobs could be withheld from companies who have poor Total Recordable Incident Rate (TRIR) scores due to non-compliant workers being injured on the job. This can cost companies money or to require them to be shut down completely. What is needed is a system to improve the ability for a company to be sure its workers are wearing all proper PPE.

Heretofore there has not been available a system or method for a tool safety system with the advantages and features of the present invention.

### BRIEF SUMMARY OF THE INVENTION

The present invention generally provides a tool safety system and method of use thereof which includes a sensor device for detecting when personal protective equipment (“PPE”) is being worn or is in proximity with an associated tool. Sensors may be included in the equipment to determine if the equipment is properly being worn, such as pressure or skin-contact sensors within gloves and hard hats, or contact switches for visors to detect that the visor is in a down position. Alternatively, simple radio frequency identification (RFID) chips could simply be placed on equipment with a receiver located on or in proximity with the tool, indicating that at the very least the PPE is in close proximity with the tool, which indicates a high likelihood that the PPE is being worn by the user. While RFID provides low-power, passive detection which should last the life of the PPE, other types of signals may also be used, such as Bluetooth, WiFi, or other wireless signals. Certification requirements to use the tool can also be provided by placing a signaling device, such as an RFID chip or Bluetooth transmitter onto the hard hat or identification badge of the user, the signaling device signaling to one or more tools that the wearer of that hat or badge is certified to use that equipment.

The tool itself could be manufactured or outfitted with a display unit, such as a series of light emitting diodes (LEDs) which are each synched to a single piece of PPE, or a simple graphical display showing similar information. The display can indicate which pieces of PPE are present and which are missing. The display unit prevents the tool from being activated until all PPE and certification identifiers are present. Alternatively, the tool could be plugged into a customized power supply device which contains the receiver unit for detecting the PPE and certification identifiers, and power won't be supplied to the tool until all PPE and identifiers are present.

### BRIEF DESCRIPTION OF THE DRAWINGS

The drawings constitute a part of this specification and include exemplary embodiments of the present invention illustrating various objects and features thereof.

FIG. 1 is a diagrammatic representation of the interaction between elements of a preferred embodiment of the present invention.

FIG. 2 is another diagrammatic representation thereof.

FIG. 3 is a side elevational view of a tool having a display unit as part of a receiver unit embodying an element of the embodiment of the present invention.

FIG. 4 shows a PPE element comprised of a hard hat embodying an element of the present invention.

FIG. 5 shows a PPE element comprised of a hard hat and visor embodying elements of the present invention.

FIG. 6 shows a PPE element comprised of safety glasses embodying an element of the present invention.

FIG. 7 shows a PPE element comprised of hearing protection ear muffs embodying an element of the present invention.

FIG. 8 shows a PPE element comprised of a work boot embodying an element of the present invention.

FIG. 9 shows a PPE element comprised of a work glove embodying an element of the present invention.

FIG. 10 shows a PPE element comprised of a safety vest and worker's badge embodying elements of the present invention.

FIG. 11 is a flow chart showing steps taken in practicing a method of the present invention.

### DETAILED DESCRIPTION OF THE PREFERRED EMBODIMENTS

I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

II. Preferred Embodiment Tool Safety System 2

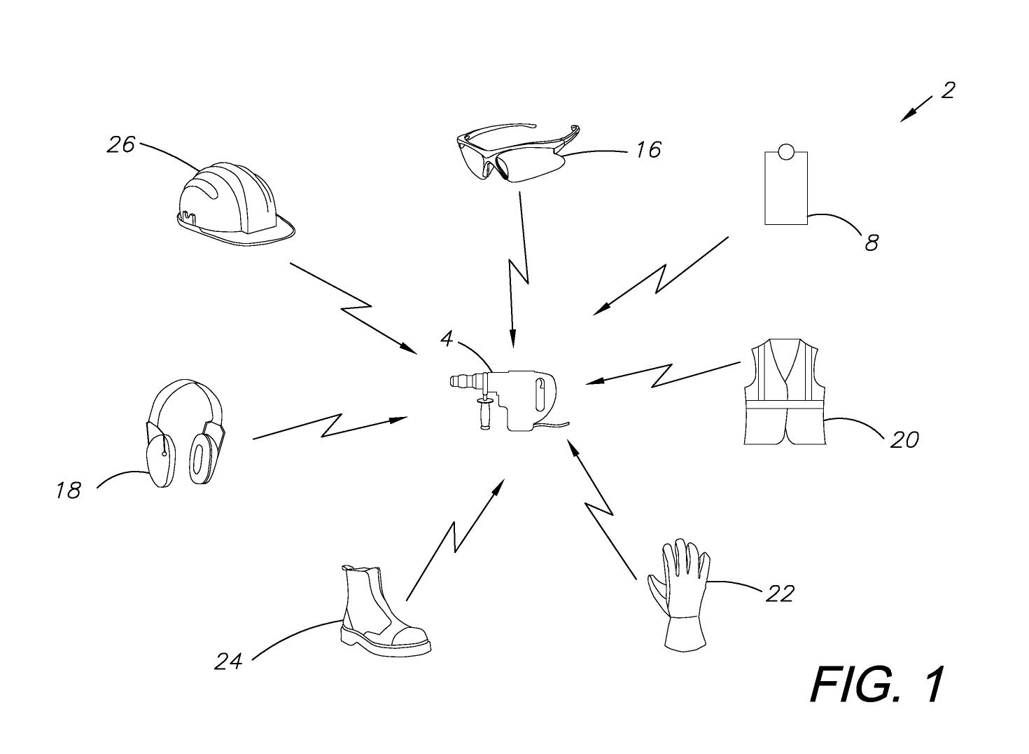

FIG. 1 shows a tool safety system 2 in a diagrammatic representation. The tool 4 is associated with a device for detecting the presence and/or use of proper personal protective equipment (“PPE”) 6. Relevant PPE 6 may include a worker badge 8, vision safety glasses 16, ear protection 18, body protection 20, hand protection 22, foot protection 24, and a hard hat 26 or other required head protection (e.g. visors or welding helmets).

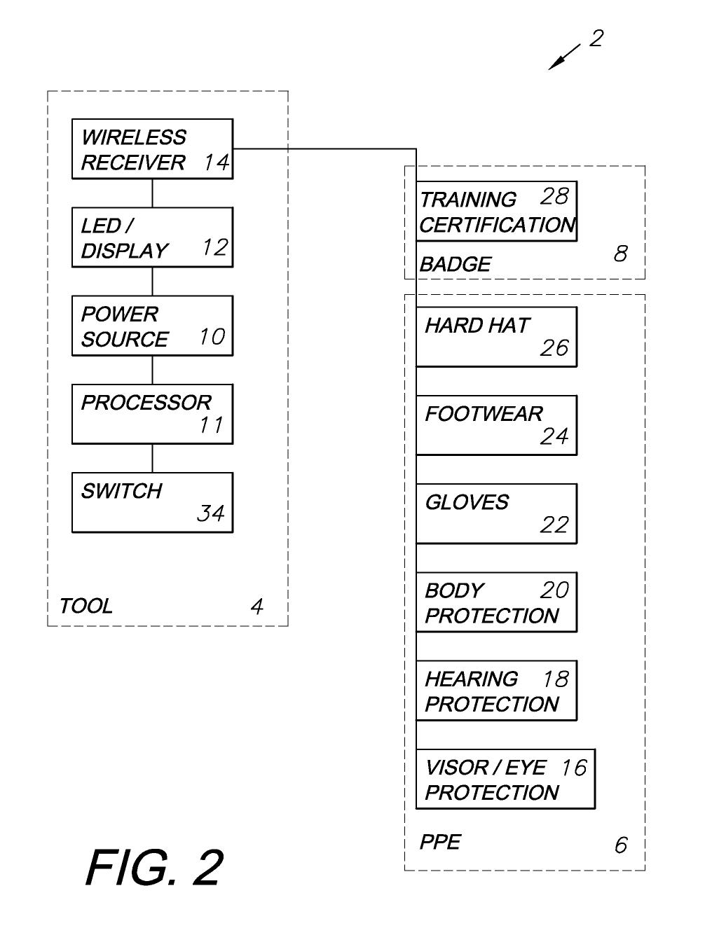

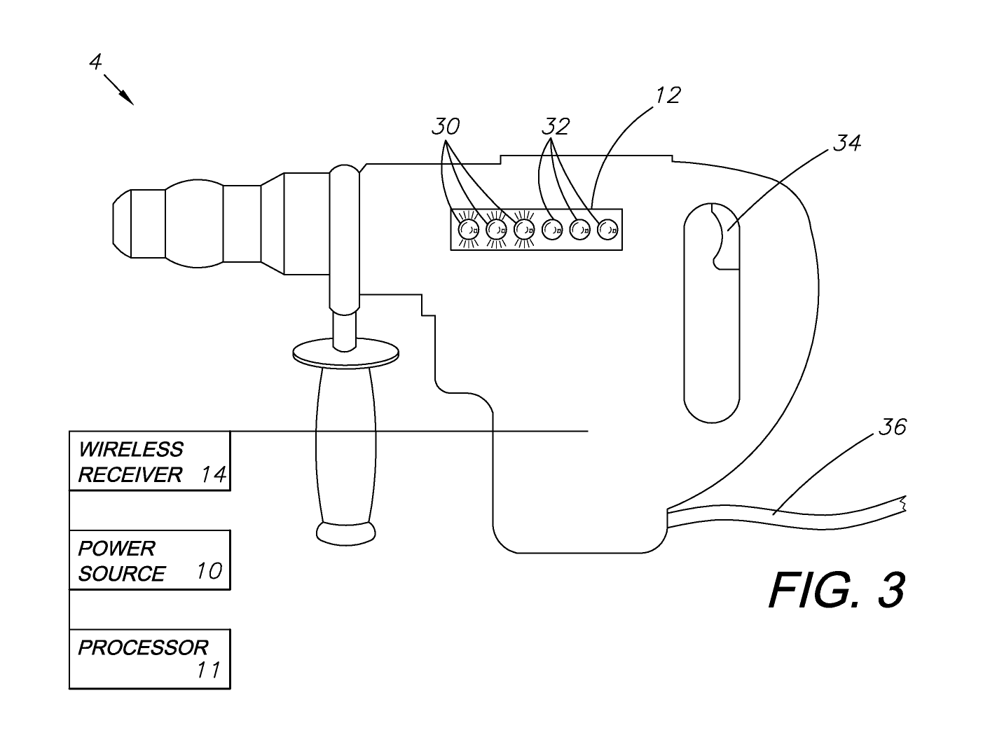

FIG. 2 shows a diagrammatic representation of the tool safety system 2 in more detail. In the embodiment as shown, the tool 4 includes a wireless receiver 14, display 12, and power source 10 for powering the display and receiver. A processor 11 may be included to set required PPE and determine if all required PPE is present. A switch 34 on the tool 4 is disengaged by the tool safety system 2 until all PPE is present. The switch 34 itself could be deactivated within the tool, or the power supply 36 may be cut off until all PPE is present. The wireless receiver 14 may detect passive frequencies from the PPE such as RFID, Bluetooth, or other wireless frequencies. If a piece of PPE is detected, the display 12 will indicate as such. As shown in FIG. 3, the display could be a series of light emitting diodes (LEDs) 30, 32, each associated with a piece of PPE. As the PPE is detected, the LEDs could either illuminate, as shown by reference numeral 30, or turn off as indicated by reference numeral 32. Alternatively, the lights could turn from a lit red-colored LED to a lit green colored LED. Alternatively, a digital display could be used to indicate whether PPE is missing and to identify what PPE is missing.

The various pieces of PPE can be wirelessly detected by the receiver 14. The PPE may include a hard hat 26, footwear 24 (e.g. steel toed boots), gloves 22, body protection 20 (e.g. safety vest), hearing protection 18 (e.g. earmuffs or ear plugs), and eye protection 16 (e.g. visor or safety glasses). In some situations, specific training certification may be required prior to operating the tool 4. In such a case, another RFID tag or wireless emitter would be associated with a training certification 28 which may be affixed to the user's hard hat or identification badge 8 or some other piece of apparel. Only users having proper certification would be allowed to operate the tool or piece of equipment.

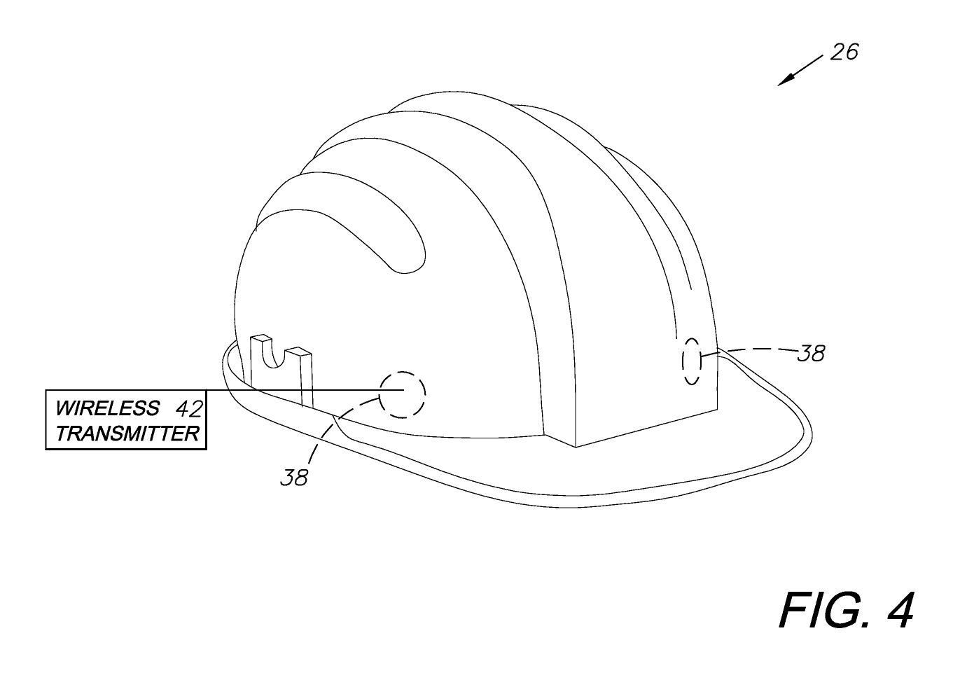

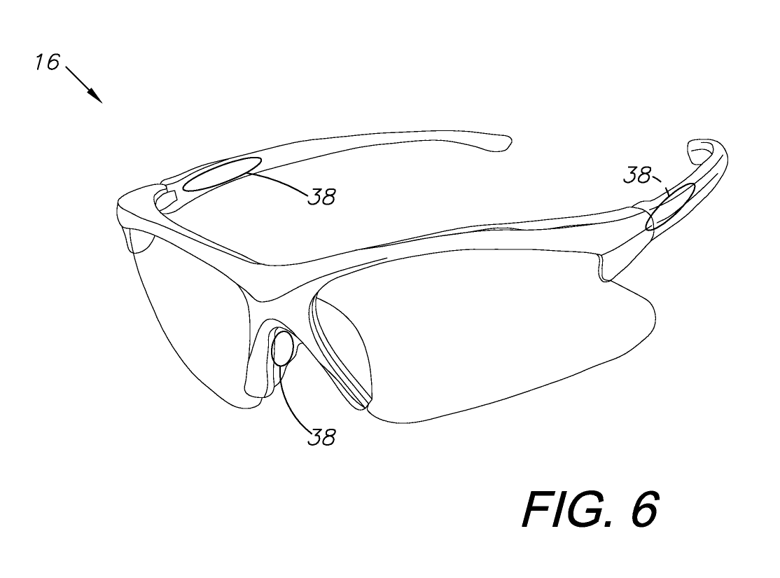

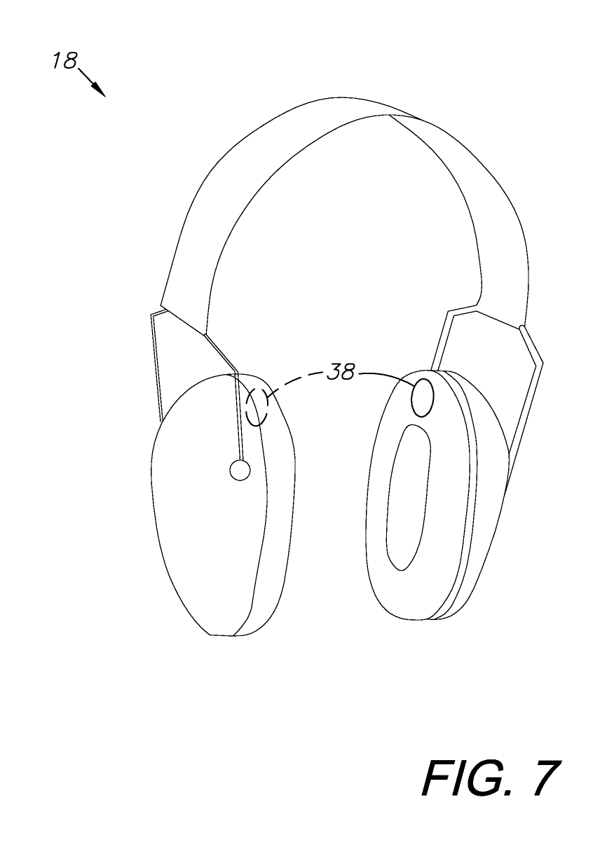

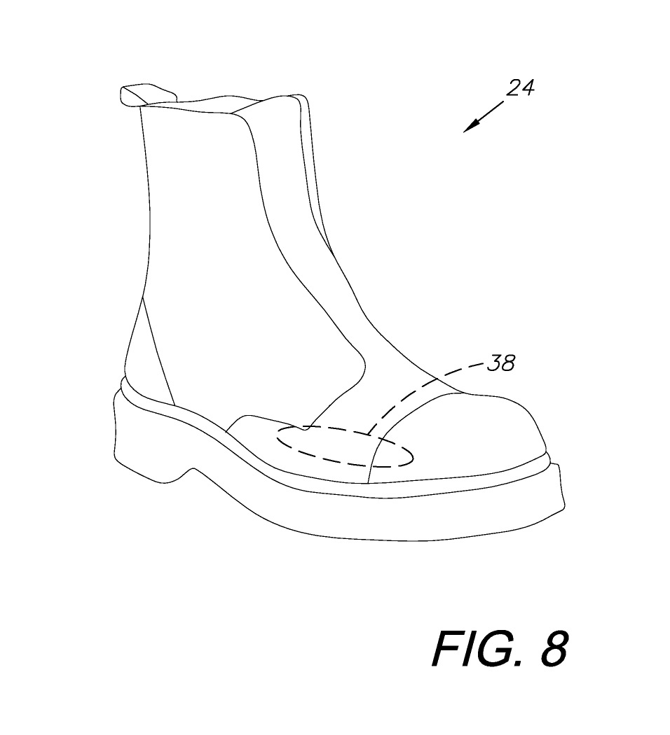

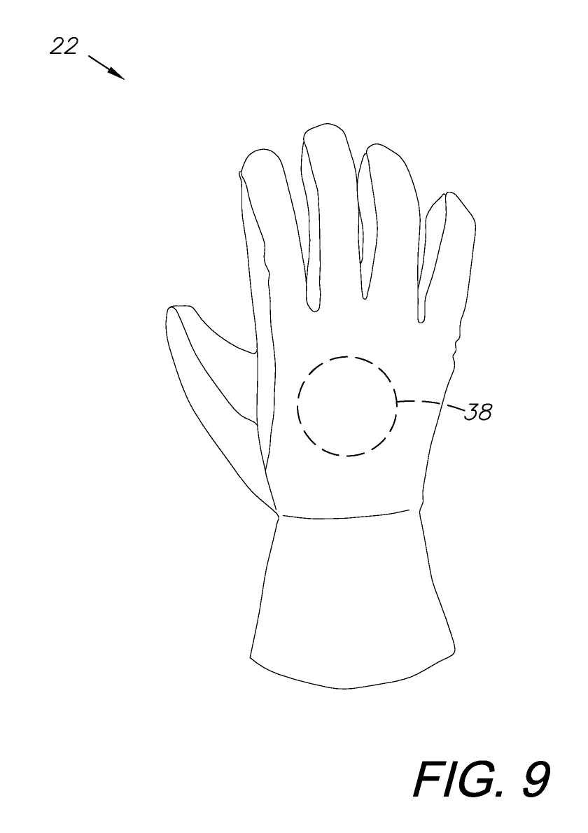

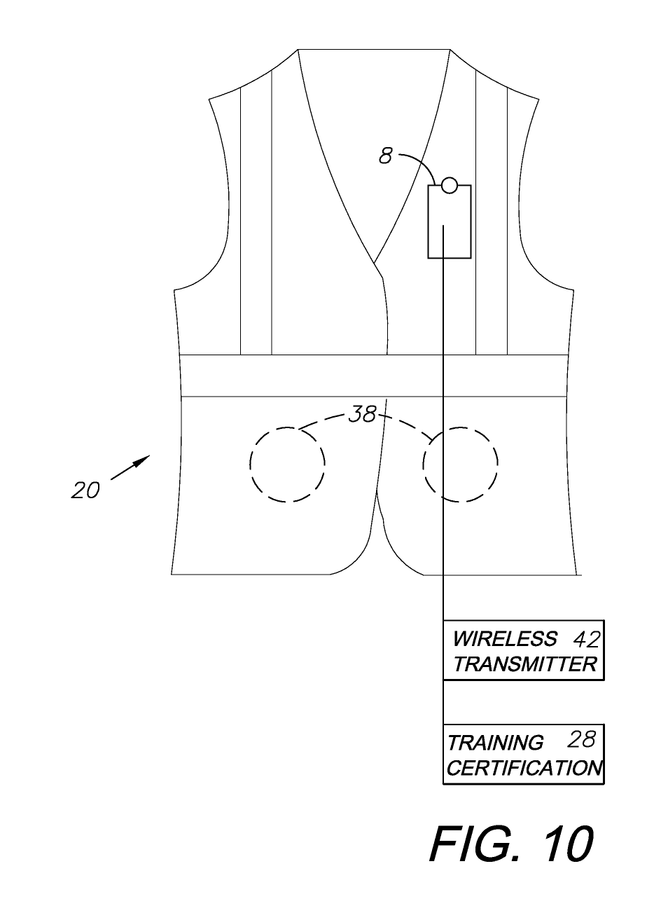

The various PPE includes sensors 38 each capable of wirelessly transmitting through a wireless transmitter 42, either passively or actively, to the wireless receiver 14 of the tool 4. The sensors may be simple proximity sensors indicating that the PPE is in range of the tool. More useful however would be pressure sensors or skin contact sensors which can actively determine if the PPE is actually being worn by the user, rather than merely in proximity with the tool. FIGS. 4 and 6-10 show how such sensors could be arranged on the inside of various PPE.

With the proximity sensors, the system could detect if the PPE is in proximity with the tool, meaning a high likelihood that the user is wearing the proper PPE. However, the user may not have their visor down or may have simply tucked their gloves into their back pocket. More advanced sensors could be used to detect when the user is actively using the PPE. Such sensors could include skin-contact or pressure sensors inside of gloves and hard hats, contact sensors to indicate a visor is in a down position, and even a key pad or other security feature to key in the user's training certification credentials.

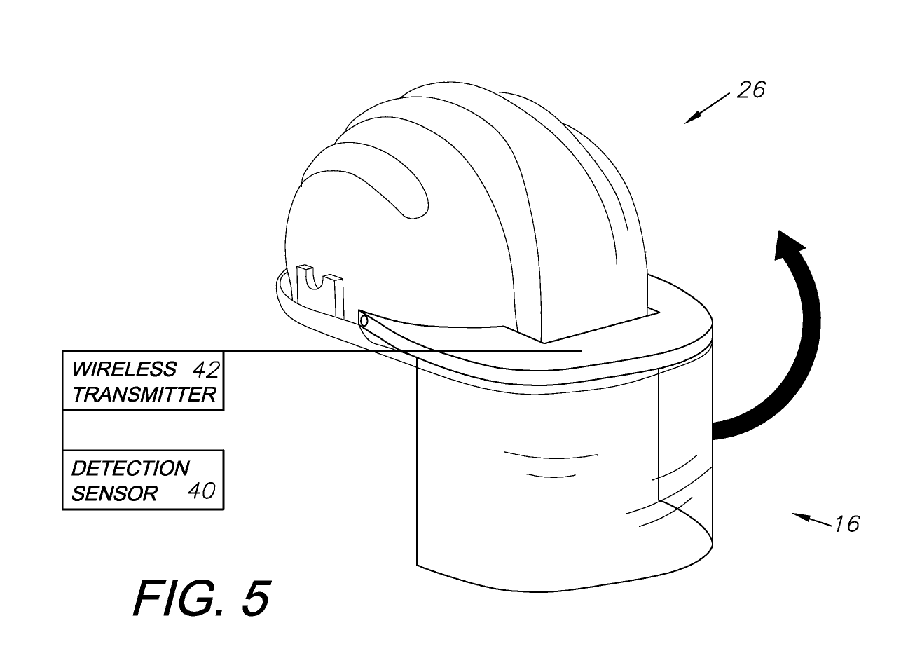

FIG. 5 shows a helmet 26 which has a tiltable visor 16 for visual protection. The visor includes a detection sensor 40, such as a gyroscope, magnetic sensor, or other sensor which can determine when the visor is in a down position. A wireless transmitter 42 is also included similar to the other sensors discussed above. This allows the PPE to transmit to the tool 4 when the visor is actively in use or to deactivate when the visor is tilted into a raised, non-use position.

The system may be installed directly into the tool 4, or may be an external element to the tool. For example, a power cord 36 could be modified with a power outlet that will not activate unless the PPE is detected, thereby preventing any power from reaching the tool. This would have to be updated depending upon the tool or piece of equipment being used, but could easily be controlled by a safety officer. Safety officers could also provide another layer of protection by being the only persons capable of removing or unlocking such safety devices on power cords 36, tools 4, or the like.

This invention could also be applied to heavy machinery, such as earth-working vehicles or other large equipment, rather than just to small tools. Proper training is required to operate most machinery, so the machinery could detect whether the party entering the machine has the proper training to operate that machine prior to allowing startup, as well as the proper safety PPE.

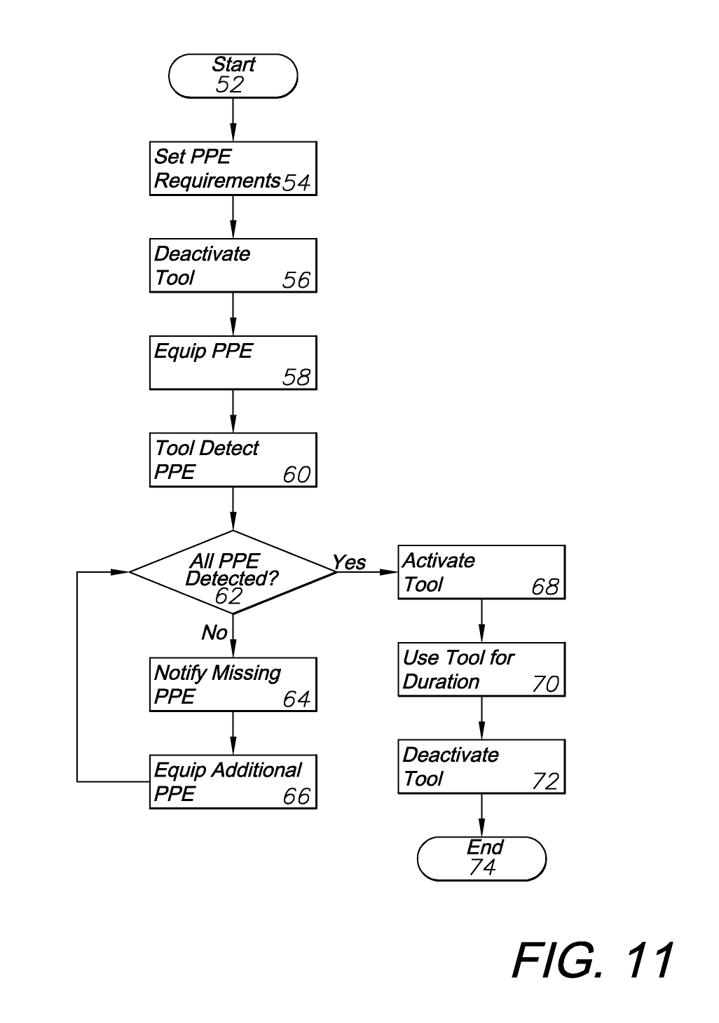

FIG. 11 shows the steps taken in an example method of practicing the present invention. The process starts at 52 and the PPE requirements are set at 54, either by a safety officer, manufacturer, or some other party prior to use of the tool. The tool is automatically deactivated at 56 until all required PPE is present. The user equips pieces of PPE at 58. The tool will passively or actively detect for the PPE at 60, depending on the type of sensor communication being used (e.g. passively detecting Bluetooth or RFID vs. actively detecting scanned PPE codes). A determination is made at 62 whether all PPE is detected. If not, the display on the tool notifies the user that PPE is missing at 64, and may even identify which PPE is missing or malfunctioning. The user will equip additional PPE at 66, and the determination will begin again at 62.

This process continues at 62 until all PPE required by the tool is detected. At that point, the tool is activated at 68 and the user may use the tool for a duration at 70. This duration can be limited based on programming within the tool safety system to only be used for certain lengths of time. After the duration of tool usage, the tool is again deactivated at 72, either manually by the user or upon the user stepping away from the tool, resulting in a detection of missing PPE. The process ends at 74.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A tool safety system comprising:
a tool having a notification display and wireless receiver;
a first piece of personal protective equipment (“PPE) having a first sensor and first wireless transmitter;
a second piece of PPE having a second sensor and second wireless transmitter;
said wireless receiver configured to determine whether said first piece of PPE and said second piece of PPE are within range of said tool;
said notification display configured to display whether said first piece of PPE and said second piece of PPE are within range of said tool as detected by said wireless receiver; and
whereby said tool is configured to remain in a deactivated state until said first piece of PPE and said second piece of PPE are detected by said wireless receiver.

2. The tool safety system of claim 1, wherein said first piece of PPE and said second piece of PPE are PPE selected from the list comprising: hard hats; visors; safety glasses; boots; gloves; body protection; worker badge; worker certification; and ear protection.

3. The tool safety system of claim 1, wherein said first sensor comprises a pressure sensor configured to determine if pressure is being exerted against said first sensor.

4. The tool safety system of claim 1, wherein said first sensor comprises a skin contact sensor configured to determine if said first sensor is in contact with skin.

5. The tool safety system of claim 1, further comprising:
said first piece of PPE comprising a hard hat;
said second piece of PPE comprising a visor connected to said hard hat; and
said second sensor comprising a tilt sensor configured to determine whether said visor is in a down, in-use position.

6. A method of operating a tool, the method comprising the steps:
acquiring a first piece of PPE having a first sensor and first wireless transmitter;
acquiring a second piece of PPE having a second sensor and second wireless transmitter;
acquiring a tool having a notification display and wireless receiver;
operating said first wireless transmitter upon activation of said first sensor;
operating said second wireless transmitter upon activation of said second sensor;
detecting with said wireless receiver said first and second wireless transmitters;
indicating with said notification display activation of said first sensor and said second sensor; and
unlocking access to operate said tool upon detecting of said first and second wireless transmitters with said wireless receiver.

7. The method of claim 6, wherein said first piece of PPE and said second piece of PPE are PPE selected from the list comprising: hard hats; visors; safety glasses; boots; gloves; body protection; worker badge; worker certification; and ear protection.

8. The method of claim 6, wherein said first sensor comprises a pressure sensor configured to determine if pressure is being exerted against said first sensor.

9. The method of claim 6, wherein said first sensor comprises a skin contact sensor configured to determine if said first sensor is in contact with skin.

10. The method of claim 6, further comprising:
said first piece of PPE comprising a hard hat;
said second piece of PPE comprising a visor connected to said hard hat; and
said second sensor comprising a tilt sensor configured to determine whether said visor is in a down, in-use position.
